(19) United States
(12) Patent Application Publication
(10) Pub. No.: US 2026/0251392 A1
(43) Pub. Date: Aug. 27, 2026

(54) DEHYDRATION DEVICE AND ASSEMBLY, AND METHOD FOR OBTAINING SUCH AN ASSEMBLY

(71) Applicant: LGD, Cergy (FR)

(72) Inventor: Jean-Gabriel DIJOUD, COLOMBES (FR)

(21) Appl. No.: 18/992,384

(22) PCT Filed: Jul. 12, 2023
(86) PCT No.: PCT/FR2023/051080

§ 371 Date: Jan. 8, 2025

(30) Foreign Application Priority Data
Jul. 13, 2022 (FR) FR2207226

(51) Int. Cl. F26B 21/25; B01D 53/04; B01D 53/26; F26B 5/04; F26B 21/33; F26B 21/40

(52) U.S. Cl. CPC F26B 21/25; B01D 53/04; B01D 53/261; B01D 53/265; F26B 5/04; F26B 21/331; B01D 2253/108; B01D 2253/308; B01D 2256/10; B01D 2257/80; B01D 2258/06; F26B 21/40

(57) ABSTRACT

This relates to a dehydration device including a drying device placed in a chamber and suitable for reducing the partial water vapor pressure in a carrier fluid. The chamber includes a separate inlet and outlet. The water-laden carrier fluid entering the chamber via the inlet comes into contact with or passes through the drying device and exits via the outlet with a lower water content. The device also includes an inlet interface of the dehydration device suitable for connection to a corresponding outlet interface of an enclosure, an outlet interface suitable for connection to a corresponding inlet interface of the enclosure, and a flow management module generating and controlling flow of carrier fluid, this flow management module applying, at the outlet of the device, a pressure at least 500 millibars lower than atmospheric pressure, and controlling the relative humidity in the carrier fluid at the outlet of the device.

### CROSS-REFERENCE TO RELATED APPLICATIONS

This application is the US national stage of PCT/FR2023/051080, filed Jul. 12, 2023 and designating the United States, which claims the priority of FR FR2207226, filed Jul. 13, 2022. The entire contents of each foregoing application are incorporated herein by reference.

### BACKGROUND OF THE INVENTION

### Field of the Invention

The present invention relates to the field of dehydration and in particular that of dehydration facilities.

### Description of the Related Art

In general, dehydration corresponds to removing the water present in a product. This operation may have various objectives, for example enabling a long conservation of a product, or concentrating some elements thereof.

In particular, dehydration comprises drying or desiccation processes under vacuum.

In particular, these methods include freeze-drying methods. Freeze-drying consists in desiccating a product frozen beforehand, by sublimation. Thus, freeze-drying is carried out by maintaining the product at a low temperature under vacuum. In the freeze-drying methods, the water extracted from the products is generally condensed by a cold plate system and then discharged from the freeze-drying facility.

Other processes of dehydration under vacuum are known.

Dehydrating under vacuum has several main advantages. Lowering the boiling point and therefore working at a lower temperature allows preserving the qualities the dehydrated product. Dehydrating in the absence of oxygen or in the presence of little oxygen avoids the oxidation of some molecules.

However, the low pressures imply very large volumes of water vapor, which should therefore be “trapped”. There are different ways for trapping water: by physisorption, chemisorption, condensation.

In general, dehydration processes under vacuum comprise the use of a condensation device, or may comprise the use of a water trap containing an adsorbent material. A facility for implementing such methods using an adsorbent material generally comprises an enclosure that receives vessels of products to be dehydrated and assemblies containing the adsorbent material. Setting the enclosure under vacuum causes an evaporation of the water initially contained in the products and the water vapor thus produced is adsorbed by the adsorbent material.

The main applications of the dehydration technologies targeted in the present invention concern the dehydration of food products, cosmetic products, and pharmaceutical products, bio-sourced products (for example, wood), or products included in the composition of such food, cosmetic or pharmaceutical products, etc.

Various dehydration devices have been known in the prior art since a very long time.

For example, document U.S. Pat. No. 2,374,232 discloses a vacuum dehydration device (in this case freeze-drying), using a desiccator material such as a silica gel. The product to be dehydrated is placed in a container which is in communication with a chamber which contains the desiccator material, which enables free gas exchanges and a pressure balance between the container where the product is placed and the chamber which contains the desiccator material.

Document FR2805759 relates to a method for dehydration in a similar system comprising at least one solid/gas reversible adsorption reactor of the common type which contains, in an enclosure, an adsorbent such as zeolite, a vat containing a product to be adsorbed (for example, placed on trays) ; and a fluid connection provided with a valve to allow setting the enclosure and the vat in communication and a pressure balance between the enclosure and the vat.

In particular, this document reminds that a method for implementing such a device conventionally comprises the following three successive phases:
an adsorption phase, during which the enclosure containing the adsorbent is set in communication with a vat containing the product to be dehydrated;
a regeneration phase, during which said enclosure containing the adsorbent is set in communication with a condensation system, said enclosure is isolated with respect to said vat, and said adsorbent is heated; and
a cooling phase, during which said enclosure is isolated and said adsorbent is cooled.

In particular, the device and the method disclosed in this document relate to the conditions applied to the adsorbent, which could nevertheless be optimized further.

Moreover, document FR2868520 discloses a facility for dehydration by zeolites in which the product to be dehydrated is positioned in a receptacle which is received in a compartment, the whole being placed in an enclosure. The objective is to place the adsorbent the closest to the dehydrated product, which, for a foodstuff, would allow better preserving the gustatory properties. Once the products have been dehydrated, the whole is extracted from the enclosure for regeneration of the zeolites. However, this manipulation is complex, and increases the cycle times of the device.

Document WO2004/043574 discloses a drying system with a chamber and a drying device located upstream of a dehydration enclosure. A drying device may also be placed downstream of the dehydration enclosure, but only when it is in the regeneration phase, so that the water removed from the drying device during the regeneration is transferred by the wet air flow originating from the dehydration enclosure. In this document, it is proposed to operate the drying system at a pressure lower than the atmospheric pressure which could be up to 400 millibars below the atmospheric pressure (600 millibars of absolute pressure).

By drying products at a pressure lower than the atmospheric pressure, the evaporation of the water of the products to be dried is promoted. Nevertheless, this considerably increases the specific volume of water vapor originating from the products.

Thus, the currently known facilities are not optimized in an overall approach with regards to the dehydration process, in order to preserve the properties of the product while allowing for an efficient implementation of the device.

### SUMMARY OF THE INVENTION

The present invention aims to provide an optimized dehydration device.

Thus, the invention relates to a dehydration device comprising a chamber and a drying device adapted to reduce the partial pressure of water vapor of a carrier fluid when said carrier fluid is in contact with said drying device or passes therethrough, said drying device being placed in said chamber.

The chamber comprises distinct inlet and outlet arranged so that the water-laden carrier fluid entering the chamber through said inlet comes into contact with or passes through the drying device and comes out through the outlet with a lower water content. The dehydration device further comprise:
an inlet interface of the dehydration device adapted to be connected to a corresponding outlet interface of a dehydration enclosure,
an outlet interface of the dehydration device adapted to be connected to a corresponding inlet interface of the dehydration enclosure,
a flow management module, adapted to generate and control the flow of carrier fluid in the dehydration device, said flow management module being configured to apply, at the outlet of the dehydration device, a pressure of at least 500 millibars lower than atmospheric pressure, and control the relative humidity in the carrier fluid at the outlet of the dehydration device.

The dehydration device comprises a device for compressing the carrier fluid, adapted to raise the pressure of said carrier fluid between the inlet interface of the dehydration device and the drying device.

The device thus proposed differs from the known devices, in particular in the food industry, operating in batches (according to the terminology which is commonplace in the industry) by a drying device, for example a water trap, remote from the dehydration enclosure. This enables, where appropriate, a regeneration of an adsorbent material present in the water trap directly in the chamber, without any particular manipulation and without immobilizing the dehydration enclosure. For example, this allows unloading and reloading the enclosure with product to be dehydrated during the regeneration of the adsorbent material. In some embodiments, this allows launching a new dehydration cycle in the dehydration enclosure using a water trap other than that one whose adsorbent material is currently being regenerated.

It is notable that the present invention primarily relates to a dehydration device independently of the dehydration enclosure intended to receive the product to be dehydrated. In particular, this allows using the dehydration device, thanks to the interfaces it comprises, to equip and update a pre-existing dehydration facility. In particular, any pre-existing dehydration tunnel may be used to form a dehydration system in accordance with the invention.

Insofar as the device proposes a vacuum dehydration, the flow management module comprises a device with a technology adapted to make the water vapor extracted from the products flow under vacuum: rotor pump (cf. hereinafter) or compressor type systems may be used.

Throughout the present document, by “vacuum”, it should be understood a pressure lower by at least 500 millibars than the atmospheric pressure, and preferably lower by 700 millibars than the atmospheric pressure.

This allows drying the product at relatively low temperatures (typically below 70° C.) and therefore less degrading the heat-sensitive molecules of the product.

Thus, the flow management module also enables a fine control of the dehydration conditions of the product that is treated, in order to preserve the desired properties (for example, the taste) thereof.

In other words, the flow management module being configured to control a dehydration under vacuum, a depression is applied at the outlet of the dehydration device. Dehydration under vacuum allows carrying it out at low temperature, which preserves some qualities of the product that is dehydrated.

Nevertheless, imposing a very low pressure increases the specific volume of water vapor. This is why a drying device is proposed, in the context of the present invention, downstream of the enclosure in which the product to be dried is placed, to reduce the partial pressure of water vapor in the carrier fluid.

Nevertheless, a low pressure has a strong negative impact on the capacity of the dryer to reduce the partial pressure of water vapor in the carrier fluid.

Typically, such a low pressure level limits the adsorption capacity of materials such as silica gels or zeolites. This is why a device for compressing the carrier fluid is provided between the dehydration enclosure and the drying device.

As regards this device for compressing the carrier fluid, once a dehydration system is formed by connecting a dehydration enclosure to the dehydration device, it allows (for example under the control of the management system) imposing two pressure levels in the system. A significant depression, by at least 500 millibars with respect to the atmospheric pressure, is imposed at the outlet of the dehydration device, and therefore in the dehydration enclosure where the product to be dehydrated is located. A lower depression, or ideally a pressure close to the atmospheric pressure or even higher than the atmospheric pressure, is obtained at the inlet of the drying device.

This promotes the reduction, by the drying device, of the water content (partial pressure of water vapor) in the carrier fluid that enters the dehydration device.

Thus, the dehydration device allows obtaining different and optimized pressure conditions on the one hand for the dehydration of a product and, on the other hand, for the reduction of the water content of the carrier fluid, in particular using a water trap.

The device for compressing the carrier fluid comprises a volumetric pump.

For example, a suitable volumetric pump may be a claw pump or a lobe pump, in particular a pump generally designated by the expressions “roots pump” or “booster pump” comprising two bilobed shaped rotors which rotate synchronously, and which is adapted to operate under vacuum. Such a pump allows controlling the suction flow rate at the inlet of the device.

In the dehydration device, a buffer balloon, forming a volume for receiving the carrier fluid, may be interposed between the device for compressing the carrier fluid and the inlet of the chamber.

The buffer balloon allows forming a reserve of vapor under overpressure in comparison with the pressure in the dehydration enclosure. This reserve enables a better control of the pressure in the drying device, and allows optimizing the operation of the drying device.

The flow management module may further be adapted to control the mass flow rate of the carrier fluid coming out of the dehydration device through its outlet interface.

The flow management module may further be adapted to control the temperature of the carrier fluid coming out of the dehydration device through its outlet interface.

The outlet of the chamber may be fluidly connected to the outlet of the dehydration device, via the flow management module.

Thus, the carrier fluid is totally or partially re-circulated, i.e. the fluid coming out of the dehydration enclosure is sent back to said dehydration enclosure after its water content has been lowered by the drying device. The set-up of this closed, or partially closed, loop allows for a better preservation of the molecules of interest (typically aromatic) in the dehydrated products.

The drying device may comprise an adsorbent material, adapted to adsorb water present in the carrier fluid.

In particular, the used adsorbent material may comprise a zeolite.

Zeolites are known for their water adsorption performances. In particular, the used zeolite may be a 4-angstrom zeolite (or 4A zeolite), i.e. an aluminosilicate crystal type with average pores measuring 4 angstroms (0.4 nm).

Alternatively, other adsorbent materials may be used, in particular:
activated alumina (or aluminum oxide);
a silica gel;
an activated carbon;
a carbon molecular sieve (often referred to as CMS according to the English acronym standing for “carbon molecular sieve”)
an absorbent
an absorbent polymer (including a bio-sourced polymer).

The drying device may comprise a system for condensing the water vapor present in the carrier fluid, for example a cold plate device.

The flow management module may also comprise a vacuum source allowing decreasing the pressure at the outlet interface of the dehydration device.

Thus, the sweeping means allows applying the pressure (i.e., in practice, the vacuum level) desired for the dehydration. The evaporation under vacuum thus achieved requires a low energy supply. The vacuum source may comprise a vacuum pump or a vacuum network. Advantageously, the vacuum supply is carried out, where necessary, according to a setpoint. In particular, this setpoint may be adapted according to the nature of the dehydrated product.

The invention also relates to a dehydration system comprising a dehydration device as described hereinabove and a dehydration enclosure, the dehydration enclosure being equipped with an inlet interface in the dehydration enclosure fluidly connected to the outlet interface of the dehydration device and an outlet interface of the dehydration enclosure fluidly connected to the inlet interface of the dehydration device.

Hence, the invention also relates to the complete system, comprising the dehydration enclosure. In particular, this enclosure may be adapted to dehydration of food products (or others) by vacuum evaporation.

The dehydration enclosure may comprise a set of shelves for receiving vessels adapted to contain a product to be dehydrated.

This configuration optimizes the ratio between the evaporation surface exposed by the product and the volume of the dehydration enclosure.

For example, the used carrier fluid may be air or nitrogen.

The use of nitrogen avoids oxidation of the product that is dehydrated. When the system implements a recycling of the carrier fluid, the nitrogen consumption of the system remains limited. The use of carbon dioxide (CO₂) is also possible.

The dehydration system may comprise a plurality of drying devices, each drying device comprising an adsorbent material adapted to adsorb water present in the carrier fluid, the system being configured so that one of the drying devices is used to reduce the water content in the carrier fluid, while the adsorbent material of another one of the drying devices is regenerated, and/or another drying device is used to dry the carrier fluid that enters the dehydration enclosure.

Thus, the device could operate, while alternating the adsorption phases and the regeneration phases on different drying devices, for example different water traps. This allows considerably increasing the operating time of the dehydration enclosure to dehydrate products.

Finally, the invention relates to a method for obtaining a dehydration system as described hereinabove, by transforming a pre-existing dehydration facility. This method comprises the following steps:
providing a dehydration facility comprising a dehydration enclosure;
providing a dehydration device as described hereinbefore,
removing the internal dehydration equipment from the dehydration enclosure,
installing on the dehydration enclosure an inlet interface of the dehydration enclosure and an outlet interface Of the dehydration enclosure, adapted to be connected respectively to the outlet interface of the dehydration device and to the inlet interface of the dehydration device,
connecting the inlet interface of the dehydration enclosure to the outlet interface of the dehydration device and connecting the outlet interface of the dehydration enclosure to the inlet interface of the dehydration device.

Thus, thanks to its one or more drying device(s) remote from the dehydration enclosure and thanks to its modular design, the device proposed in the invention allows retrofitting pre-existing facilities. For example, this allows converting freeze-drying tunnels into a dehydration system in accordance with the present invention.

Other particularities and advantages of the invention will appear better in the description hereinafter.

### BRIEF DESCRIPTION OF THE DRAWINGS

In the appended drawings, given as non-limiting examples:

FIG. 1 shows, according to a block diagram, a dehydration device and a dehydration system in accordance with embodiments of the present invention,

FIG. 2 shows, according to a simplified industrial diagram, a dehydration system in accordance with an embodiment of the invention.

### DETAILED DESCRIPTION

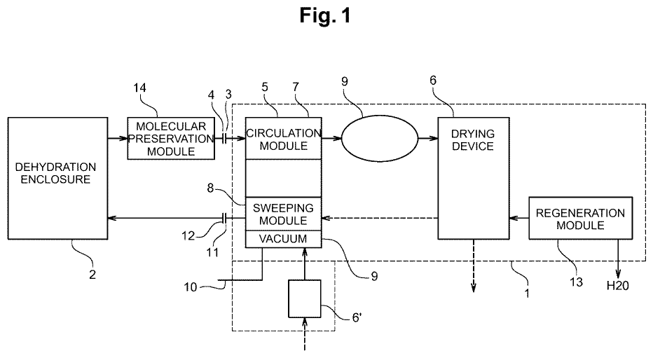

FIG. 1 shows, according to a block diagram, a dehydration system according to an embodiment of the present invention. The dehydration system comprises a dehydration device 1, which is the primary object of the present invention, and a dehydration enclosure 2 to which the dehydration device 1 is connected.

The dehydration device 1 comprises an inlet interface of the dehydration device 3 through which a carrier fluid containing water in gaseous form penetrates the dehydration device for drying. The inlet interface of the dehydration device 3 is intended to be connected to an outlet interface of the corresponding dehydration enclosure 4. The carrier fluid is a gas, which may be air or advantageously nitrogen.

The inlet interface of the dehydration device 3 and the outlet interface of the dehydration enclosure 4 ensure a fluidic connection between the dehydration enclosure 2 and the dehydration device 1. Thus, these interfaces may be in various forms, they may be screwed, flanged, welded, etc.

The dehydration device comprises a flow management module 5.

In particular, the flow management module 5 is intended to ensure the circulation of the carrier fluid in the dehydration system, and thus control the relative humidity level in the dehydration enclosure 2. Thus, it also allows controlling the flow rates and the pressure in the drying device 6 (described hereinafter).

In the illustrated example, the flow management module itself consists of two inter-operating modules, namely a circulation module 7 and a sweeping module 8.

In the illustrated example, the circulation module 7 is positioned downstream of the inlet interface of the dehydration device 3. The circulation module is primarily intended to generate and control the carrier fluid flow in the dehydration device. In this example, it comprises a piece of mechanical equipment, of the rotor pump type (roots pump), or any other equipment adapted to operate under high vacuum and to manage the flow rate of the carrier fluid at the outlet of the dehydration enclosure and consequently at the inlet of the drying device. This equipment also forms a device for compressing the carrier fluid. The compression device allows raising the pressure of the carrier fluid between the inlet interface of the dehydration device and the drying device.

Throughout the present document, the upstream concept and the downstream concept should be understood according to the direction of flow of the carrier fluid.

Optionally, a buffer balloon 9 may be arranged between the mechanical equipment of the circulation module 7 and the drying device 6. The buffer balloon 9 allows for a better control and smoothing over time of the operating conditions of the drying device 6 (pressure and temperature).

The use of mechanical equipment also has the advantage of enabling a recompression of the carrier fluid before it enters the drying device.

Nevertheless, alternatively, in one embodiment where the carrier fluid is not (or not totally) recycled to the inlet of the dehydration enclosure, as explained hereinafter, the circulation module may be formed by a device for controlling the pressure differential between the outlet and the inlet of the dehydration device. In this case, it is essentially a pressure difference between a vacuum source and an atmosphere that could cause the flow of carrier fluid in the dehydration enclosure 2 and in the dehydration device 1. In the case where the carrier fluid is not totally recycled, or, in general, if it is necessary to perform a supply of carrier fluid in the dehydration system, the introduced carrier fluid could be air or another gas dried in a second drying device 6′ of the dehydration device.

In all embodiments, the circulation module may comprise a device for determining the relative humidity of the carrier fluid entering the dehydration device 1, for example a humidity sensor, and use this information for controlling the flow rates in the dehydration system.

As mentioned hereinabove, the dehydration device comprises a drying device 6 intended to capture the water present in the carrier fluid originating from the dehydration enclosure.

In general, the drying device 6 is arranged in a chamber of the dehydration device.

The drying device 6 allows lowering the amount of water present in the carrier fluid that is present around the drying device or passes therethrough.

Thus, the drying device may comprise a cold plate device which causes condensation of the water present in the vapor form in the carrier fluid at the surface of said cold plates.

Alternatively, the drying device may comprise a material adapted to adsorb a large amount of water, so-called adsorbent material, under appropriate temperature and pressure conditions.

Zeolites are known for their high capacity to adsorb water, without taking in volume, and could therefore be used as an adsorbent material of a water trap.

The adsorbent material may be installed in a basket or a rack arranged in the chamber containing the drying device 6, so as to be brought into contact, or to be passed through, where appropriate, by the vapor-laden carrier fluid that penetrates the water trap.

The flow control module 5 further comprises a sweeping module 8.

In particular, the sweeping module 8 allows controlling the amount of air that enters the dehydration enclosure 2.

It also allows controlling some characteristics thereof, namely the pressure and/or the temperature.

For example, it allows maintaining the desired vacuum level by a vacuum supply made with a vacuum source 10, for example a vacuum pump or a vacuum unit (via a vacuum network).

The dehydration device 1 comprises an outlet interface of the dehydration device 11, through which the dried carrier fluid comes out of the dehydration device to be used for drying or evaporating a product in a dehydration enclosure.

The outlet interface of the dehydration device 11 is intended to be connected to an inlet interface of the corresponding dehydration enclosure 12.

The outlet interface of the dehydration device 11 and the inlet interface of the dehydration enclosure 12 ensure a fluid connection between the dehydration device 1 and the dehydration enclosure 2.

Like the inlet interface of the dehydration device 3 and the outlet interface of the dehydration enclosure 4, these interfaces may be in various forms, they may be screwed, flanged, welded, etc.

The previously-described means of the dehydration device enable operation thereof to dehydrate a product present in a dehydration enclosure 2 connected to said device, described in more detail hereinafter. Nevertheless, in the case where the drying device is a water trap, the adsorbent material having adsorbed a large amount of water should be regenerated by desorbing the water it contains, so that it recovers its adsorption capacity.

For this purpose, the dehydration device comprises a regeneration module 13.

The regeneration module 13 allows setting the adsorbent material of the water trap under temperature and pressure conditions suitable for regeneration thereof. In particular, the regeneration module may be configured to carry out a vacuum regeneration.

The regeneration module 13 is selected and configured according to the general operating mode of the dehydration device. Advantageously, the latter can operate in vacuum-assisted adsorption, in particular in vacuum swing adsorption (VSA according to the English acronym standing for “Vacuum Swing Adsorption”), in which a low pressure is imposed during the regeneration and a relatively higher pressure is imposed during the adsorption.

The dehydration device thus developed is connected (via the inlet interface of the dehydration device 3 and the outlet interface of the dehydration device 11) to a dehydration enclosure 2 in order to form a dehydration system in accordance with the invention.

The dehydration enclosure 2 may be produced for this purpose, or may alternatively be a pre-existing enclosure, for example a freeze-drying tunnel that we wish evolve into a system in accordance with the present invention.

In such a system, the dehydration enclosure 2 is adapted to receive the products to be dehydrated. It is adapted to operate at the target pressure during the dehydration of the products.

Thus, a generally tubular shape is particularly well-suited to systems operating at a high vacuum level. This enclosure may have large dimensions to enable the dehydration of products on an industrial scale. For example, a tubular enclosure with an internal diameter of about 2.5 m and an internal length of 5 m may be used. These dimensions are given merely as examples. In particular, systems whose chamber has a much larger volume may be considered.

The enclosure 2 comprises a suction tubing allowing discharging the air-laden carrier fluid (typically air and water vapor). Thus, the suction tubing comprises the outlet interface of the enclosure 4.

The enclosure 2 comprises an inlet tubing allowing ensuring the supply of carrier fluid allowing ensuring a sweeping flow in the enclosure 2. Thus, the inlet tubing comprises the inlet interface of the enclosure 12.

The arrangement of the suction tubing and of the inlet tubing (in particular tapping thereof in the enclosure) is selected so as to promote a uniform sweeping of the internal volume of the enclosure 2.

Of course, the enclosure is provided with a door allowing loading and unloading the products to be dehydrated.

Advantageously, the products may be loaded on trays or vessels, suited for food contact where appropriate. The treated products may be in solid or liquid (including pasty) form. The configuration of the enclosure tends to maximize the exchange surface of the products with the carrier fluid, for example with air.

In order to promote dehydration thereof, in a dry carrier fluid, the products to be dehydrated may be heated (nevertheless, under vacuum, the dehydration is carried out at low temperature, which allows not altering some qualities of the treated products).

Finally, in addition to the low dehydration temperature and the complete or partial recycling of the carrier fluid, a molecular preservation module 14 may be interposed in the carrier fluid flow coming out of the enclosure. The molecular preserving module 14 comprises a molecular sieve so that only the water in gaseous form comes out of the enclosure with the carrier fluid, and not some molecules of interest (in particular aromatic compounds) which are thus kept in the environment of the product being dehydrated. Hence, the molecular preservation module 14, which is optional, could be located at any point of the flow between the dehydration enclosure 2 and the flow management module 5: in the dehydration enclosure 2, between the dehydration enclosure 2 and the dehydration device 1, or at the inlet of the dehydration device 1.

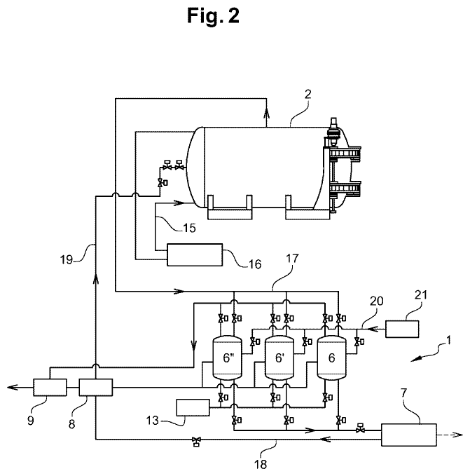

FIG. 2 shows, according to a simplified industrial diagram (most valves, sensors, vents, and peripheral systems being omitted), an example of a dehydration system in accordance with an embodiment of the invention.

The system comprises a dehydration enclosure 2 in which the product to be dehydrated is placed.

A heating circuit 15 associated with a thermoregulating system 16 allows heating the product present in the dehydration enclosure 2, using a heat-transfer fluid.

In the illustrated example, the dehydration device comprises three drying devices, namely three water traps 6, 6′, 6″. Each water trap comprises a 4-angstrom zeolite bed as an adsorbent material. The used carrier fluid is air, under low pressure. The flow is created in the device using a rotor pump of the flow module 7 of the flow management module. In the illustrated example, the circulation module 7 is placed downstream of the water traps 6, 6′, 6″. As regards these inlet tubings 17 (which are connected to the outlet interface of the enclosure 2), the dehydration device is configured so that each water trap may be, or not, crossed by the carrier fluid and the water vapor originating from the dehydration enclosure 2. Thus, a valve is provided at the inlet of each water trap to enable or prevent entry of the water vapor-laden carrier fluid.

In particular, only one of the water traps may be used to adsorb the water present in the carrier fluid originating from the enclosure 2. By passing through a water trap, the carrier fluid is dried by adsorption of the water vapor it contains in the zeolite of the crossed water trap.

The outlet tubing of the water trap is fluidly connected to the equipment of the circulation module 7 adapted to create the carrier fluid flow. The carrier fluid then flows towards the sweeping module 8, via a return line 18.

The sweeping module 8 controls the carrier fluid flow directed towards the inlet interface of the enclosure 2 via an outlet tubing 19. If a vacuum supply is necessary, the pressure could be reduced by the vacuum source 9, herein in the form of a vacuum pump.

If a supply of dry carrier fluid is necessary, this supply could be made via a supply branch 20 which draws air into the atmosphere throughout a filter 21, and dries it in one of the water traps 6, 6′, 6″ of the dehydration device, different from the water trap then used to dry the carrier fluid originating from the dehydration enclosure 2.

Thus, alternatively to the device shown in FIG. 2, all of the dry carrier fluid introduced into the enclosure may be derived from the supply branch 20, whereas there is no return line 18 and the circulation module comprises a vacuum pump (as equipment for generating the flow) that discharges the dried carrier fluid in the atmosphere.

Finally, while one of the water traps 6, 6′, 6″ is used to recover the water originating from the product contained in the dehydration enclosure, and optionally another one is used for supplying dry carrier fluid, a water trap could be simultaneously regenerated. For this purpose, the regeneration module 13 ensures heating of the air sucked in into the water trap being regenerated, whereas the vacuum source enables depression of the water trap in order to carry out a regeneration under vacuum.

Hence, the invention thus developed primarily allows forming a dehydration device, adapted to form a dehydration system when it is associated with a suitable dehydration enclosure. The use of a sweeping module allows controlling the dehydration conditions of the product that is treated, in order to preserve the desired properties (for example, the taste) thereof. It also allows optimizing the conditions of water adsorption by the adsorbent material of the water trap. Finally, it allows for an energy optimization of the dehydration process. The modular approach proposed in the invention, as well as the separation of the water traps with respect to the enclosure (enabled by circulation means adapted to create a flow under low pressure), also allows considering making existing dehydration facilities evolve into a system in accordance with the present invention.

1. A dehydration device comprising
a chamber and a drying device configured to reduce a partial pressure of water vapor of a carrier fluid when said carrier fluid is in contact with said drying device or passes through said drying device, said drying device being disposed in said chamber,
wherein the chamber comprises an inlet and a separate outlet arranged so that the water-laden carrier fluid entering the chamber through said inlet comes into contact with or passes through the drying device and exits the chamber through the outlet of the chamber with a lower water content,
the dehydration device further comprising:
an inlet interface of the dehydration device adapted to be connected to a corresponding outlet interface of a dehydration enclosure,
an outlet interface of the dehydration device adapted to be connected to a corresponding inlet interface of the dehydration enclosure,
a flow management module, adapted to generate and control a flow of the carrier fluid in the dehydration device,
said flow management module being configured to apply, at an outlet of the dehydration device, a pressure of at least 500 millibars lower than atmospheric pressure, and to control a relative humidity in the carrier fluid at the outlet of the dehydration device, and
a compressor configured to compress the carrier fluid, adapted to raise the pressure of said carrier fluid between the inlet interface of the dehydration device and the drying device.

2. The dehydration device according to claim 1, wherein the carrier fluid compressor comprises a volumetric pump.

3. The dehydration device according to claim 1, further comprising a buffer balloon configured to form a volume for receiving the carrier fluid, the buffer balloon being interposed between the carrier fluid compressor and the inlet of the chamber.

4. The dehydration device according to claim 1, wherein the flow management module is configured to control a mass flow rate of the carrier fluid coming out of the dehydration device through the outlet interface of the dehydration device.

5. The dehydration device according to claim 1, wherein the flow management module is configured to control a temperature of the carrier fluid coming out of the dehydration device through the outlet interface of the dehydration device.

6. The dehydration device according to claim 1, wherein the outlet of the chamber is fluidly connected to the outlet of the dehydration device, via the flow management module.

7. The dehydration device according to claim 1, wherein the drying device comprises an adsorbent material, adapted to adsorb water present in the carrier fluid.

8. The dehydration device according to claim 1, wherein the drying device comprises a system for condensing the water vapor present in the carrier fluid.

9. The dehydration device according to claim 1, wherein the flow management module comprises a vacuum source configured to decrease the pressure at the outlet interface of the dehydration device.

10. A dehydration system comprising the dehydration device according to claim 1 and a dehydration enclosure, the dehydration enclosure comprising an inlet interface of the enclosure fluidly connected to the outlet interface of the dehydration device and an outlet interface of the enclosure fluidly connected to the inlet interface of the dehydration device.

11. The dehydration system according to claim 10, wherein the dehydration enclosure comprises a set of shelves for receiving vessels adapted to contain a product to be dehydrated.

12. The dehydration system according to claim 10, wherein the carrier fluid is air or nitrogen.

13. The dehydration system according to claim 10, comprising a plurality of drying devices, each of the plurality of drying devices comprising an adsorbent material adapted to adsorb water present in the carrier fluid, the system being configured so that one of the drying devices is used to reduce the water content in the carrier fluid, while the adsorbent material of another one of the drying devices is regenerated, and/or another one of the drying devices is used to dry the carrier fluid that enters the dehydration enclosure.

14. A method for obtaining the dehydration system according to claim 10 by transforming a pre-existing dehydration facility, the method comprising:
providing the dehydration facility comprising a dehydration enclosure;
providing the dehydration device in accordance with claim 1,
removing internal dehydration equipment from the dehydration enclosure,
installing on the dehydration enclosure an inlet interface of the dehydration enclosure and an outlet interface of the dehydration enclosure, configured to be connected respectively to the outlet interface of the dehydration device and to the inlet interface of the dehydration device,
connecting the inlet interface of the dehydration enclosure to the outlet interface of the dehydration device and connecting the outlet interface of the dehydration enclosure to the inlet interface of the dehydration device.

15. The dehydration device according to claim 2, further comprising a buffer balloon configured to form a volume for receiving the carrier fluid, the buffer balloon being interposed between the carrier fluid compressor and the inlet of the chamber.

16. The dehydration device according to claim 15, wherein the flow management module is configured to control a mass flow rate of the carrier fluid coming out of the dehydration device through the outlet interface of the dehydration device.

17. The dehydration device according to claim 16, wherein the flow management module is configured to control a temperature of the carrier fluid coming out of the dehydration device through the outlet interface of the dehydration device.

18. The dehydration device according to claim 17, wherein the outlet of the chamber is fluidly connected to the outlet of the dehydration device, via the flow management module.

19. The dehydration device according to claim 18, wherein the drying device comprises an adsorbent material, adapted to adsorb water present in the carrier fluid.

20. The dehydration device according to claim 19, wherein the drying device comprises a system for condensing the water vapor present in the carrier fluid.
